(19) United States
(12) Patent Application Publication
(10) Pub. No.: US 2010/0329640 A1
(43) Pub. Date: Dec. 30, 2010

(54) Recording/Reproducing Apparatus

(75) Inventors: Mitsuhiro Okada, Yokohama (JP); Tomoyuki Nonaka, Chigasaki (JP); Yuichi Nonaka, Yokohama (JP); Hironori Komi, Tokyo (JP); Akira Tokai, Kakogawa (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi Consumer Electronics Co., Ltd., Tokyo (JP)

(21) Appl. No.: 12/769,490

(22) Filed: Apr. 28, 2010

(30) Foreign Application Priority Data
Jun. 30, 2009 (JP) 2009-154540

(51) Int. Cl. H04N 13/00; H04N 5/91

(52) U.S. Cl. 386/252; 386/E05.003; 348/E13.001; 386/357

(57) ABSTRACT

A recording/reproducing apparatus, for enabling recording/reproducing of a three-dimensional (3D) video stream, by taking a display environment into the consideration thereof, comprises: a stream distinguishing means for distinguishing the three-dimensional (3D) video stream; a 3D/2D stream converting for converting the three-dimensional (3D) video stream distinguished by the stream distinguishing means into a two-dimensional (2D) video stream; and a conversion indicating means for indicating to execute the 3D/2D conversion, wherein the three-dimensional (3D) video stream is converted into the two-dimensional (2D) video stream by the 3D/2D stream means, when the 3D/2D conversion is indicted in the conversion indicating means.

This application relates to and claims priority from Japanese Patent Application No. 2009-154540 filed on Jun. 30, 2009, the entire disclosure of which is incorporated herein by reference.

### BACKGROUND OF THE INVENTION

The present invention relates to a recording/reproducing apparatus.

As the background technology in the present technical field is already known, for example, the following Patent Document 1. In that document is described the following: “The present invention is characterized, in a display apparatus for enabling to display 2D and 3D, in particular, when making display for use of 2D, a 2D video and audio signal is displayed as it is (as 2D) while a 3D video and audio signal is converted into 2D to be displayed, and when making display for use of 3D, the 3D video and audio signal is displayed as it is (as 3D) while the 2D video and audio signal is converted into 3D to be displayed, and further the dimension conversion operation is so controlled that the conversion between those of the same dimension (i.e., double conversion) will not executed.”

### <Prior Art Documents>

### <Patent Documents>

[Patent Document 1] Japanese Patent Laying-Open No. 2006-121553 (2006).

### BRIEF SUMMARY OF THE INVENTION

In the Patent Document 1 mentioned above, although there is mentioned a method for displaying the 2D video and audio signal by converting it into the 3D video and audio signal, or for displaying the 3D video and audio signal by converting it into the 2D video and audio signal, fitting to a display mode, but no description in relation to a method for recording the 3D video and audio signal

According to the present invention, there is provided or proposed a recording/reproducing apparatus for recoding a three-dimensional (3D) video and audio stream, by taking a display environment into the consideration thereof.

The object mentioned above is accomplished by the invention described in the pending claims.

According to the present invention, it is possible to record the three-dimensional (3D) video and audio stream, by taking the display environment into the consideration thereof. Problem (s) to be dissolved, structure (s) and an effect (s) other than those mentioned above will be apparent from the explanation of the embodiment, which will be given hereinafter.

### BRIEF DESCRIPTION OF THE SEVERAL VIEWS OF THE DRAWING

FIG. 1 is a view for showing an example of a first embodiment of a recording apparatus, according to an embodiment of the present invention;

FIG. 2 is a flowchart for showing the operations of the apparatus shown in FIG. 1;

FIGS. 3A and 3B are views for showing examples of screen displays of a recording menu;

FIG. 4 is a view for showing an example of the structure of a 3D/2D converting means;

FIG. 5 is a view for showing an example of a decoded image of the 3D video and audio stream, and images converted from that decoded images for the left eye and the right eye;

FIG. 6 is a view for showing an example of a method for producing the two-dimensional (2D) image;

FIG. 7 is a view for showing the structure 3D/2D converting means through stream search;

FIG. 8 is a view for showing an example of a method for converting a video stream;

FIG. 9 is a view for showing an example of the structure of a normal converting means; and

FIG. 10 is a view for showing an example of a recording/reproducing apparatus, according to a second embodiment.

### DETAILED DESCRIPTION OF THE PREFERRED EMBODIMENTS

Hereinafter, embodiments according to the present invention will be fully explained by referring to the attached drawings.

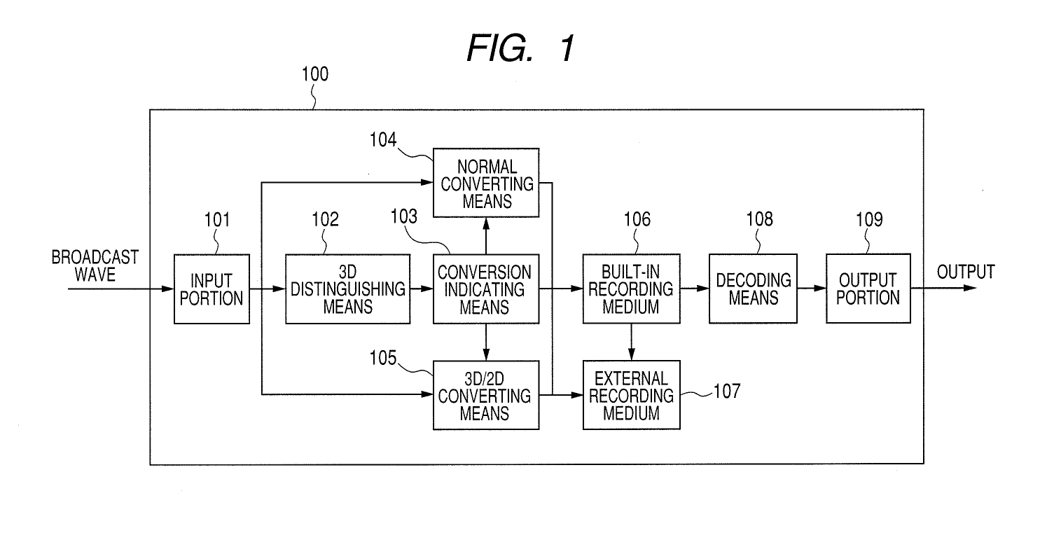

FIG. 1 shows a recording/reproducing apparatus for presenting a first embodiment of the present invention, and it is a recorder 100 having a function of recording/reproducing both the three-dimensional (3D) video and audio and audio steam and the two-dimensional (2D) video and audio stream.

An input portion 101 receives a broadcast wave, and it decodes it into a video and audio stream, EPG information, and data broadcast information, etc. In a 3D distinguishing means 102, from a result of executing analysis on the EPG information, the data broadcast information and the video and audio stream mentioned above (for example, header information of a stream, etc.) or the like, distinction or determination is made on whether it is the three-dimensional (3D) video and audio stream or not. In a conversion indicating means 103, indication is made on whether a normal recording should be executed, or recording should be executed after converting the three-dimensional (3D) video and audio stream into the two-dimensional (2D) video and audio stream. In a normal converting means 104, although re-encoding is executed into an arbitrary bit rate, but it may pass the signal therethrough without using the re-encoding function, when no deterioration is desired on the picture quality. In a 3D/2D converting means 105, the three-dimensional (3D) video and audio stream is converted into the two-dimensional (2D) video and audio stream. A built-in recording medium 106 presents a recoding medium, which cannot be removed, such as, a HDD, etc., and an external recording medium 107 presents a recording medium, which can taken out, such as, a DVD, a BD and a SD card, etc., for example. In a decoding means 108, decoding is made on the two-dimensional (2D) video and audio stream and the three-dimensional (3D) video and audio stream. An output portion 109 converts a decoded video and audio, which is decoded by the decoding means, into an output format, and thereby to output it. In case when providing an output to a HDMI terminal, for example, the decoded video and audio is converted into the transmission format of the HDMI, and it is outputted, attaching a copy control signal thereto. Though it is common that this copy control signal is outputted with executing a copy guard on all of the videos and audios; however, there is a case where it becomes a copy free since the picture quality is deteriorated when converting the video and audio of a HD size into the video and audio of a SD size, and in the similar manner to that, in case of the two-dimensional (2D) video and audio stream that is converted by the 3D/2D converting means 105 mentioned above, since the picture quality is deteriorated, it is also possible to make the control of not executing the copy guard. With this, it is possible to protect contents of the three-dimensional (3D) video and audio, and the two-dimensional (2D) video and audio converted into the two-dimension (2D) can be copied, freely.

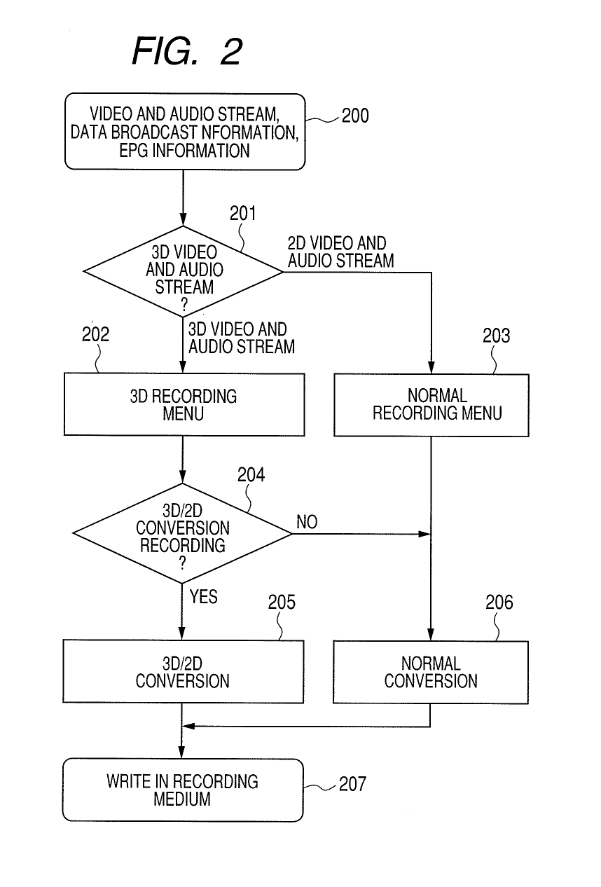

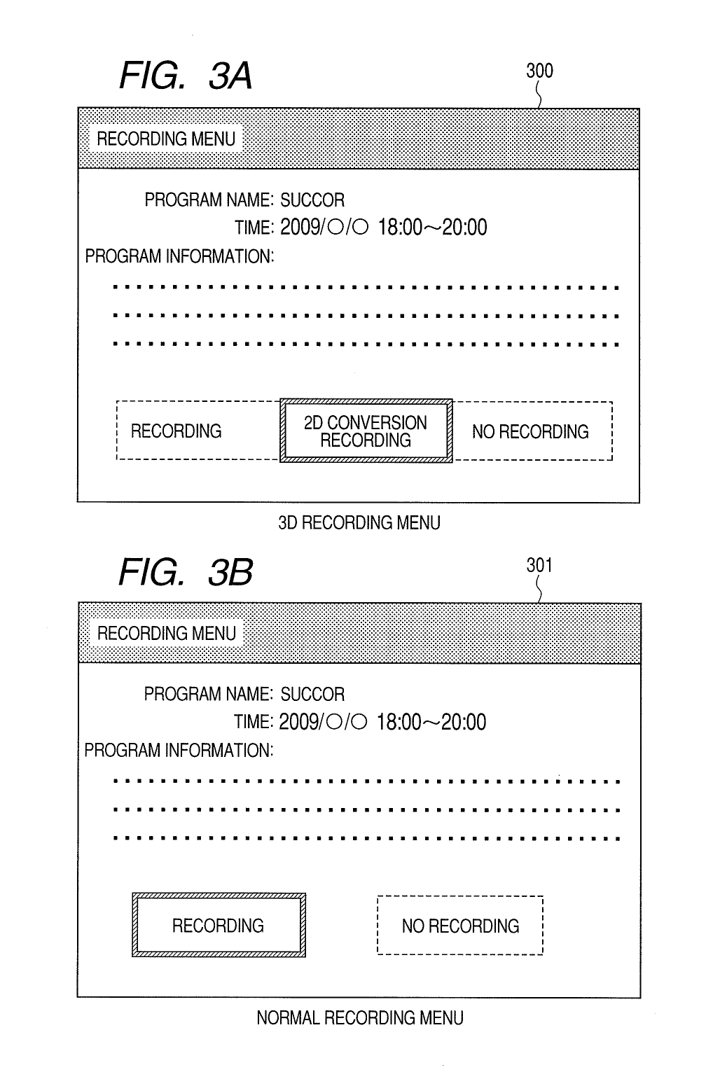

By referring to the flowchart shown in FIG. 2, explanation will be made on the operations when recoding by the recording/reproducing apparatus shown in FIG. 1. First of all, as a result of analysis of a stream, determination is made on whether it is the data broadcast information or not, and from the information of EPG information (in step 200), determination is made on whether it is the three-dimensional (3D) video and audio stream or not (step 201). Next, if it is the three-dimensional (3D) video and audio stream, a 3D recoding menu is displayed (step 202), and if the two-dimensional (2D) video and audio stream, a normal recoding menu is displayed (step 203). In FIGS. 3A and 3B are shown examples of the recording program menu. The 3D recoding menu 300 has both, a selection of a normal recording and a selection of recoding after conducting the 3D/2D conversion, and can be selected, arbitrarily, by a user. On the other hand, the normal recoding menu 301 does not display a selection of recording after conducting the 3D/2D conversion. With this, it is possible to prevent the user from selecting an erroneous selection, i.e., conducting 3D/2D conversion on the two-dimensional (2D) video and audio stream. On the 3D recoding menu (step 204), when selection is made on a 3D/2D conversion recording, then the 3D/2D conversion is executed (step 205). On the other hand, when selecting the normal recoding, then the normal conversion is executed within the normal converting means 104 mentioned above (step 206). Finally, the video and audio stream is written into the built-in recording medium or the external recording medium (step 207).

As was mentioned above, for the recording/reproducing apparatus according to the present invention, it is possible to reserve the three-dimensional (3D) video and audio stream by converting it into the two-dimensional (2D) video and audio stream, and also select to reserve the three-dimensional (3D) video and audio stream as it is. With this, the two-dimensional (2D) video and audio stream is recoded when there is only a display environment of the two-dimensional (2D) video and audio stream. The three-dimensional (3D) video and audio stream is recorded when there is the display environment of the three-dimensional (3D) video and audio stream. There is the display environment of the three-dimensional (3D) video and audio stream, but when the user wishes to see it as the two-dimensional (2D) video and audio, or when she/he wishes to reduce a recoding capacity, then the two-dimensional (2D) video and audio stream is recorded. As was mentioned above, an arbitrary recording can be made depending on the display environment.

In the embodiment 1 mentioned above, the explanation is made on the example of the broadcast wave as the input signal; however it may be an IP broadcast, etc., but not the broadcast wave.

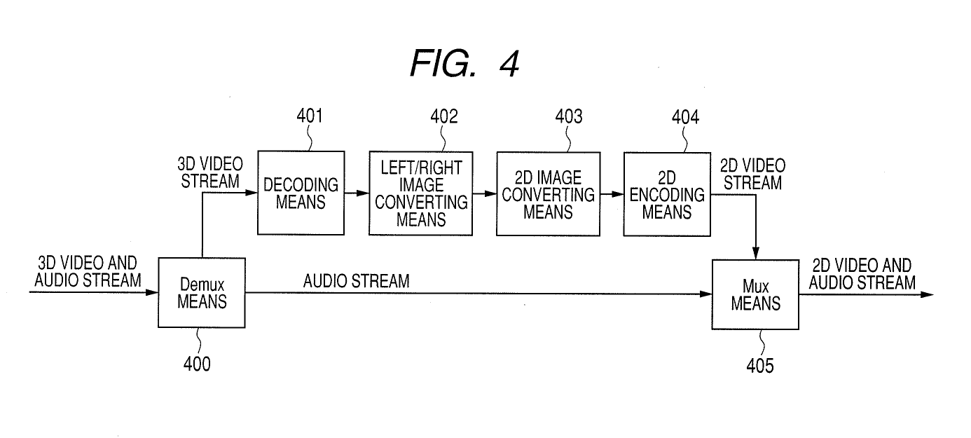

FIG. 4 shows an example of detailed conversion of the 3D/2D converting means 105 mentioned above.

First of all, a Demux means 400 divides the three-dimensional (3D) video and audio stream inputted into three-dimensional (3D) video stream (in this case, only the video stream) and an audio stream. Next, within a decoding means 401, the three-dimensional (3D) video stream is decoded so as to produce a decoded image. Herein, since the decoding means 401 has the same function to the decoding means 108 shown in FIG. 1, it may be used in common with.

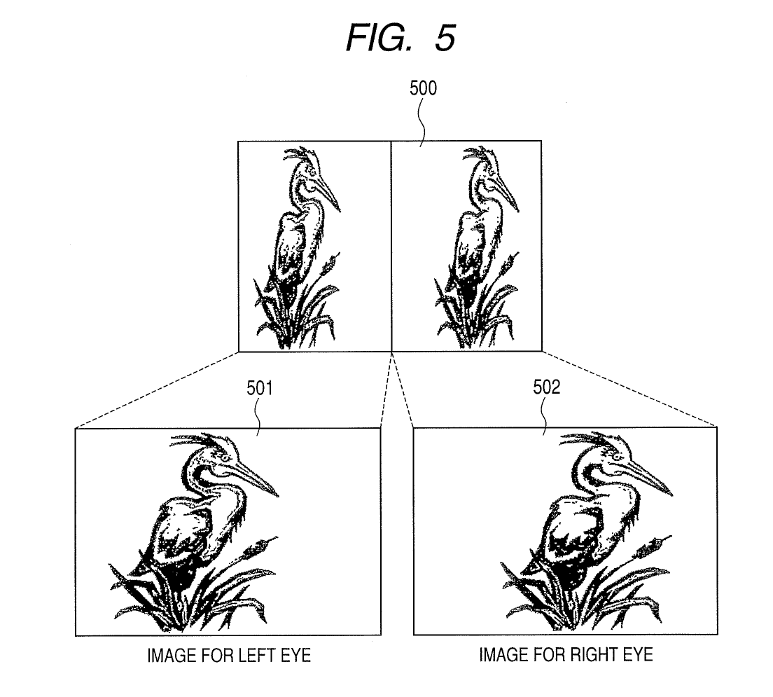

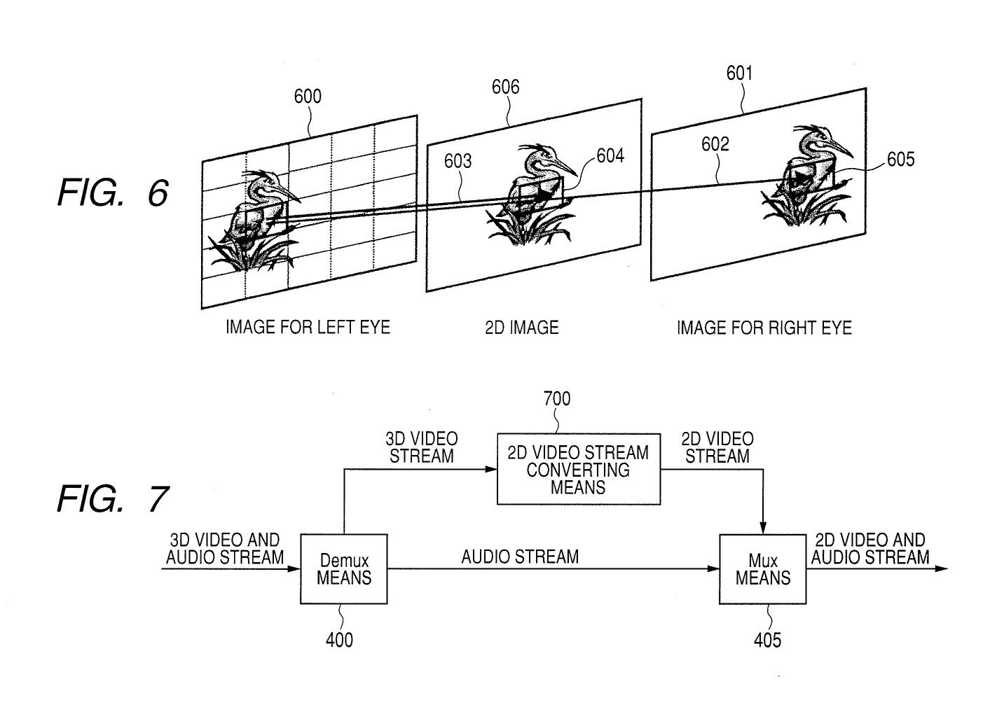

FIG. 5 shows an example of the decoded image. The decoded image 500 is the decoded image of the three-dimensional (3D) video and audio stream, which is encoded in accordance with a side-by-side method. This displays the image for the left eye on the left-hand side and the image for the right eye on the right-hand side within one frame, simultaneously. In this manner, the image transmitted in the special format is converted into the image for the left eye and the image for the right eye within a left/right image converting means 402. For example, in case of the decoded image 500 shown in FIG. 5, an image 501 for the left eye and an image 502 for the right eye are produced by executing a process for enlarging them by 2 times (×2) in the horizontal direction. Next, with using the image for the left eye and the image for the right eye, the two-dimensional (2D) image is produced within a 2D image converting means. For example, from only one image, such as, only the image for the left eye, or the image for the right eye, the two-dimensional (2D) image may be produced, or the two-dimensional (2D) image may be produced from two (2) pieces of images for the left eye and for the right eye. As an example, explanation will be made on a method for producing the two-dimensional (2D) image by obtaining a moving quantity (i.e., a motion vector) from image 600 of the left eye and image 601 for the right eye shown in FIG. 6. First of all, the image 600 for the left eye is divided into arbitrary rectangular areas or regions, and for each of the rectangular regions is obtained or found a most matching position thereto, within the image 601 for the right eye (e.g., the position where the sum of absolute value difference or the sum of square difference, etc., falls down to the minimum). The above-mentioned most matching position is the moving quantity of that rectangular region. In FIG. 6, the moving quantity of one (1) rectangular region of the image 600 for the left eye is presented by a vector 602. With using the motion vector 602 mentioned above, the two-dimensional (2D) image is produced. In more details, a rectangular region 605 at the position of the motion vector 602 is brought to a rectangular region 604 at the position of a motion vector 603, which is obtained by dividing the motion vector 602 into a half. This operation is executed on all of the divided rectangular regions of the image 600 for the left eye, and thereby producing a two-dimensional (2D) image 604. If producing the two-dimensional (2D) image 604 with this method, normal images for the left eye and the right eye are in such that an object at the center thereof is shifted to the left or the right a little bit, since there is the parallax; however, it is possible to bring the object into the angle of view of photographing the object from a visual point locating at a center between the left eye and the right eye. Other than the example mentioned above, as is shown in Japanese Patent Laying-Open No. 2003-244659 (2003), for example, it is also possible to input the images for the left eye and the right eye into a frame-rate converting apparatus, for interpolating image between two (2) frames continuing time-sequentially, with considering them as time-sequentially continuing frames, and thereby to apply the image obtained therefrom as the two-dimensional (2D) image. In this case, similar to the effect mentioned above, it is also possible to convert the images for the left eye and the right eye into those of the angle of view, being photographed from the visual point locating at the center between the left eye and the right eye.

The two-dimensional (2D) image produced in the left/right video converting means 402 is encoded within a 2D encoding means 404, and thereby producing the two-dimensional (2D) video stream. Finally, the two-dimensional (2D) video stream (only the video stream) mentioned above and the audio stream are multiplexed in a Mux means 405 with keeping synchronization between them, and the two-dimensional (2D) video stream is produced.

In the converting method mentioned above, though the explanation was given on the video, which is encoded in the side-by-side format, as an example; however, by changing the converting methods of the left/right image converting means 402 and the 2D video converting means 403, it is the structure of being compatible even if a compression format of the three-dimensional (3D) video stream (only the video stream) is any one. Also, since re-encoding is executed, there can be obtained a characteristic of being adjustable to an arbitrary bit rate. Further, since it is enough to add the left/right video converting means and the 2D image converting means to the existing decoder and encoder, it can be achieved, cheaply.

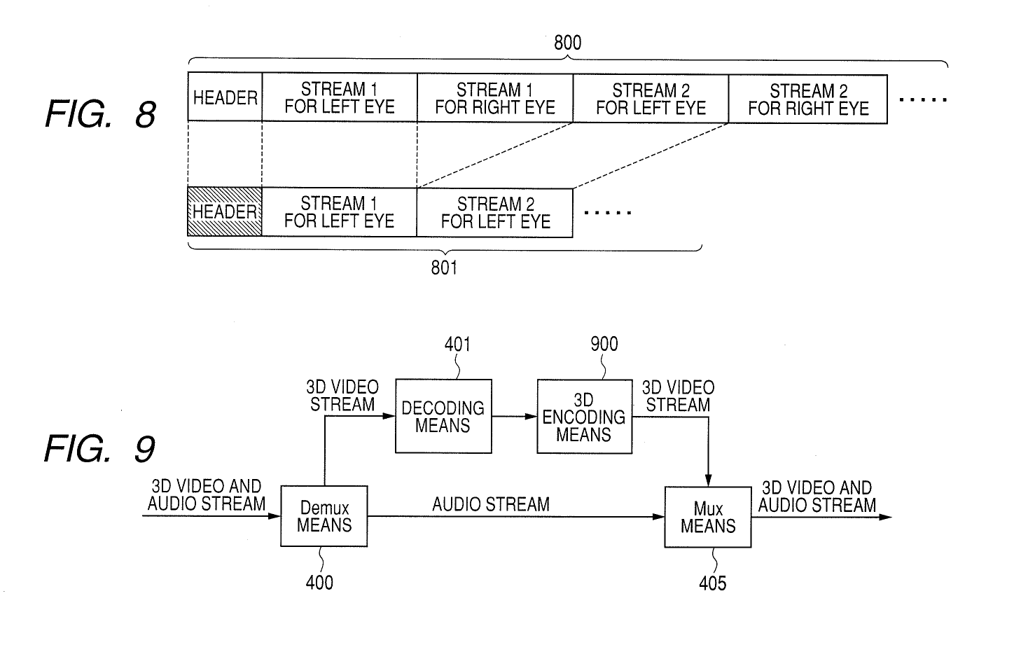

In FIG. 7 is shown other conversion of the 3D/2D converting means 105. Since those doing the same operations are attached with the same reference numerals, then the explanation thereof will be omitted herein. In this method, the three-dimensional (3D) video stream (only the video stream) is converted into the two-dimensional (2D) video stream (only the video stream), by removing unnecessary information thereof, within a 2D video stream converting means 700. An example will be explained by referring to FIG. 8. It is assumed that the stream for the left eye and the stream for the right eye are encoded each other, mutually, as the three-dimensional (3D) video stream (only the video stream) 800, and that the image for the left eye is compressed without using a correlation of the image for the right eye. Under this condition of an assumption, within the 2D video stream converting means 700, a stream is searched, and thereby determining a stream header, a stream for the left eye and a steam for the right eye, and wherein a two-dimensional (2D) video stream (only the video stream) 801 is produced by combining the steam for the left eye. In this instance, since the stream for the right eye is removed, then it is also necessary to change the stream header.

With the converting method mentioned above, there is no necessity of executing the re-encoding on the image decoded, on the structure thereof, and since it is possible to achieve the conversion into the two-dimensional (2D) video stream, only by rewriting the header information, after taking out only one of the streams by conducting the search of the three-dimensional (3D) video stream, it is possible to execute the conversion at high speed. Further, since there is no necessity of executing the re-encoding, it is possible to suppress the consumption of electric power. Also, since the 3D/2D conversion can be achieve by only conducting the search of stream, it can be implemented by software, without adding hardware, and therefore it can be achieved cheaply.

FIG. 9 shows a block diagram when executing a bit-rate conversion of the three-dimensional (3D) video stream, within the normal recording means. Since those doing the same operations are attached with the same reference numerals, then the explanation thereof will be omitted herein. In the bit-rate conversion of the three-dimensional (3D) video stream, the three-dimensional (3D) video stream is decoded within the decoding means 401, and the decoded image is re-encoded into the three-dimensional (3D) video stream, with adjusting coding parameters, such as, quantization value, etc., within a 3D encoding means 900.

Normally, only the bit-rate conversion is executed, however; the three-dimensional (3D) image may be encoded within the 3D encoding means 900 after changing the format thereof, with adding a 3D format changing means between the decoding means 401 and the 3D encoding means 900. With the structure of adding the 3D format changing means, it is also possible to deal with, even if display equipment is of other format.

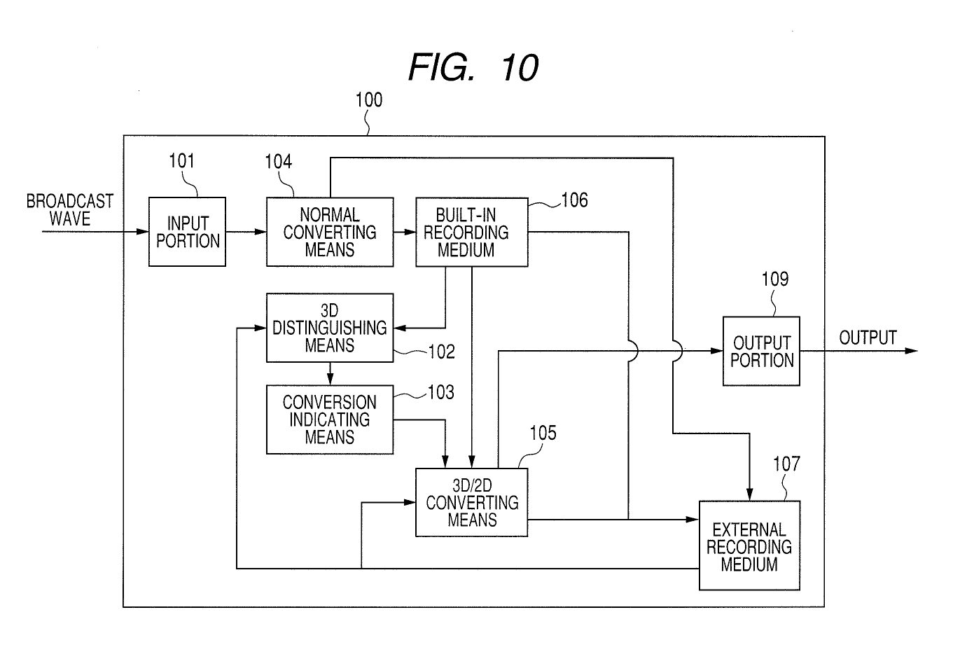

FIG. 10 depicts the recoding/reproducing apparatus for showing a second embodiment of the present invention, and it is an example of executing the 3D/2D conversion when reproducing the three-dimensional (3D) video and audio stream, which is recorded in the built-in recording medium, or the external recording medium, and thereby outputting the video and audio. Since each block of the recording/reproducing apparatus shown in FIG. 1 does not change herein, then it is attached with the same reference numeral in FIG. 1, and detailed explanation of the function thereof will be omitted; and explanation will be given on a dataflow.

First of all, the video and audio stream inputted from the input portion 101 is recorded in the built-in recording medium 106 or the external recording medium 107, by the normal recording means 104. When reproducing the video and audio stream recording in the built-in recording medium, or the external recording medium, it is determined if it is the three-dimensional (3D) video and audio stream or not, within the 3D distinguishing means 102. If a result of that determination is the three-dimensional (3D) video and audio stream, then it is determined on whether the three-dimensional (3D) video and audio should be outputted upon operation of button (s) of a remote controller by a user, or the two-dimensional (2D) video and audio should be outputted by converting the three-dimensional (3D) video and audio into the two-dimensional (2D) video and audio, and it is indicated by the conversion indicating means 103. Herein, assuming that the 3D/2D converting means 203 has the structure shown in FIG. 4, the three-dimensional (3D) video stream is decoded within the decoding means 401, and the three-dimensional (3D) video after conversion thereof into the video for the left eye and the video for the right eye within the left/right image converting means 402 is transmitted to the output portion, when outputting the three-dimensional (3D) video and audio. On the other hand, when outputting the two-dimensional (2D) video and audio, the two-dimensional (2D) video and audio is produced from the image for the left eye and the image for the right eye, within the 2D image converting means 403.

With applying the structure shown in FIG. 10, it is possible to select; i.e., output the three-dimensional (3D) video and audio or the two-dimensional (2D) video and audio, fitting the three-dimensional (3D) video and audio stream recorded in the built-in recording medium, or the external recording medium to the display equipment, by changing the dataflow through the blocks having the same functions shown in FIG. 1. For example, with storing the three-dimensional (3D) video and audio stream in the built-in recording medium, it is possible the following; e.g., the three-dimensional (3D) video and audio is outputted when the user views on a 3D-capable TV in a living room, or the two-dimensional (2D) video and audio is outputted after conducting the 3D/2D conversion thereon, when the user views on a 3D-incapable TV in a bedroom.

Also, with the structure shown in FIG. 10, while saving the video and audio in the form of the three-dimensional (3D) video and audio stream, it is possible to record the two-dimensional (2D) video and audio stream, which is executed with the 3D/2D conversion, into the built-in recording medium or the external recording medium, again, depending on necessity thereof. Herein, when recoding the two-dimensional (2D) video and audio stream, after conducting the 3D/2D conversion on the three-dimensional (3D) video and audio stream recorded in the built-in recording medium, into the built-in recording medium, again, an menu, i.e., whether the three-dimensional (3D) video and audio stream before the conversion should be deleted or not, is displayed on a screen of the display equipment, so as to enable the user to select it; then, at the same, the user can delete the three-dimensional (3D) video and audio stream before the conversion, while remaining only the two-dimensional (2D) video and audio stream converts, and thereby improving the usability thereof.

Further, also when reproducing the three-dimensional (3D) video and audio stream recorded in the built-in recording medium, or the external recording medium, it is possible for the user to select to output the three-dimensional (3D) video and audio or to output after converting it into the two-dimensional (2D) video and audio, fitting to the capability with 3D (i.e., 3D-capable or 3D-incapable) of the display equipment, but also the recording/reproducing apparatus may output, automatically executing the 3D/2D conversion when the display equipment mentioned above is not compatible with 3D display on the display equipment information thereof, obtaining the display equipment information of if it is 3D-capable or not from the display equipment. With such automatic execution of the 3D/2D conversion as mentioned above, for the user, it is not necessary to make a setup.

In all of the examples mentioned above, mentioning was made about the recoding/reproducing apparatus for recording, after converting from the three-dimensional (3D) video and audio stream into the two-dimensional (2D) video and audio stream; however, it can be achieved with the same structure when converting, not the three-dimensional (3D) video and audio stream, but N-dimensional video and audio stream, into the two-dimensional (2D) video and audio stream.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A recording/reproducing apparatus, for enabling recording/reproducing of a three-dimensional (3D) video and audio stream, comprising:
a stream distinguishing unit, which is configured to distinguish the three-dimensional (3D) video and audio stream;
a 3D/2D stream converting unit, which is configured to convert the three-dimensional (3D) video and audio stream distinguished by said stream distinguishing unit into a two-dimensional (2D) video and audio stream; and
a conversion indicating unit, which is configured to indicate to execute said 3D/2D conversion, wherein
the three-dimensional (3D) video and audio stream is converted into the two-dimensional (2D) video and audio stream by said 3D/2D stream converting unit, when the 3D/2D conversion is indicted in said conversion indicating unit.

2. The recording/reproducing apparatus, as described in the claim 1, wherein
said conversion indicating unit indicates to convert there-dimensional (3D) video stream into two-dimensional (2D) video stream by said 3D/2D stream converting unit, only when a result of distinction of said stream distinguishing unit is the three-dimensional (3D) video and audio stream.

3. The recording/reproducing apparatus, as described in the claim 1, wherein
said 3D/2D stream converting unit comprises; a Demax unit, which is configured to divide the three-dimensional (3D) video stream into the three-dimensional (3D) video stream and an audio stream; a decoding unit, which is configured to decode said produce three-dimensional (3D) video stream, so as to produce decoded image; a left/right image converting unit, which is configured to convert from said decoded image into images for left eye and for right eye; a 2D image changing unit, which is configured to select either one of said image for left eye and said image for right eye; a 2D encoding unit, which is configured to encode two-dimensional (2D) image selected into a two-dimensional (2D) video stream; and a Mux unit, which is configured to multiplex said two-dimensional (2D) video stream after said encoding and an audio stream.

4. The recording/reproducing apparatus, as described in the claim 1, further comprising:
a recording medium, on which said three-dimensional (3D) or said two-dimensional (2D) video and audio stream can be recorded;
a decoding unit, which is configured to decode the three-dimensional (3D) or the two-dimensional (2D) video and audio stream recorded, so as to produce a decoded video and audio; and
an output portion, which is configured to output said decoded video and audio to an outside, with attaching a copy control signal thereto, wherein
copy guard is not applied in said output portion, when outputting the decoded video and audio of the two-dimensional (2D) video and audio stream, which is converted from the three-dimensional (3D) video and audio stream into the two-dimensional (2D) video and audio stream within said 3D/2D stream converting unit.

5. The recording/reproducing apparatus, as described in the claim 1, further comprising:
a recording medium, on which said three-dimensional (3D) or said two-dimensional (2D) video and audio stream can be recorded; and
a decoding unit, which is configured to decode the three-dimensional (3D) or the two-dimensional (2D) video and audio stream recorded, so as to produce a decoded video and audio, wherein
the three-dimensional (3D) video and audio stream reserved on said recording medium is converted into the two-dimensional (2D) video and audio stream by said 3D/2D stream converting unit, while receiving display equipment information from an external display equipment on whether it is compatible with the three-dimensional (3D) video and audio or not, when said display equipment information indicates that it is the equipment that is not compatible with the three-dimensional (3D) video and audio, and thereby outputting that decoded video and audio into an outside.

6. The recording/reproducing apparatus, as described in the claim 1, further comprising:
a recording medium, on which said three-dimensional (3D) or said two-dimensional (2D) video and audio stream can be recorded, wherein an menu screen is displayed on an external display equipment, on whether the three-dimensional (3D) video and audio stream should be deleted or not after the conversion, when the three-dimensional (3D) video and audio stream reserved on said recording medium is converted into the two-dimensional (2D) video and audio stream by said 3D/2D stream converting unit, to be reserved on said recording medium, again.

7. A converting apparatus, for converting a three-dimensional (3D) video and audio stream into a two-dimensional (2D) video and audio stream, comprising:
a Demax unit, which is configured to divide the three-dimensional (3D) video and audio stream into the three-dimensional (3D) video stream and an audio stream;
a decoding unit, which is configured to decode said produce three-dimensional (3D) video stream, so as to produce decoded image;
a left/right image converting unit, which is configured to convert from said decoded image into images for left eye and for right eye;
a 2D image changing unit, which is configured to produce a two-dimensional (2D) image having an angle of view of photographing from a position at a center between the left eye and the right eye, from two (2) pieces of said images for the left eye and the right eye;
a 2D encoding unit, which is configured to encode said two-dimensional (2D) image, so as to produce a two-dimensional (2D) video stream; and
a Mux unit, which is configured to multiplex said two-dimensional (2D) video stream after said encoding and an audio stream.

8. The converting apparatus, as described in the claim 7, wherein
further said 2D image changing unit inputs the images for the left eye and the right eye into a frame-rate converting apparatus for interpolating an image between two (2) frames, continuing time-sequentially, by considering those as the images continuing time-sequentially, and provides the image obtained therefrom as the two-dimensional (2D) image.

9. The recording/reproducing apparatus, as described in the claim 1, wherein
said 3D/2D stream converting unit comprises: a Demax unit, which is configured to divide the three-dimensional (3D) video and audio stream into the three-dimensional (3D) video stream and an audio stream; a decoding unit, which is configured to decode said produce three-dimensional (3D) video stream, so as to produce decoded image; a left/right image converting unit, which is configured to convert from said decoded image into images for left eye and for right eye; a 2D image changing unit, which is configured to produce a two-dimensional (2D) image having an angle of view of photographing from a position at a center between the left eye and the right eye, from two (2) pieces of said images for the left eye and the right eye; a 2D encoding unit, which is configured to encode said two-dimensional (2D) image so as to produce a two-dimensional (2D) video stream; and a Mux unit, which is configured to multiplex said two-dimensional (2D) video stream after said encoding and an audio stream.

10. A converting apparatus, for converting a three-dimensional (3D) video and audio stream into a two-dimensional (2D) video and audio stream, comprising:
a Demax unit, which is configured to divide the three-dimensional (3D) video and audio stream into the three-dimensional (3D) video stream and an audio stream;
a 2D video stream converting unit, which is configured to convert the three-dimensional (3D) video stream into the two-dimensional (2D) video stream, by removing either one stream of the three-dimensional (3D) video stream for a left eye or for a right eye thereof, each image being encoded one by one for the left eye or for the right eye; and
a Mux unit, which is configured to multiplex said two-dimensional (2D) video stream after said encoding and an audio stream.

11. The recording/reproducing apparatus, as described in the claim 1, wherein
said 3D/2D stream converting unit comprises: a Demax unit, which is configured to divide the three-dimensional (3D) video stream into the three-dimensional (3D) video stream and an audio stream; a 2D video stream converting unit, which is configured to convert the three-dimensional (3D) video stream into the two-dimensional (2D) video stream, by removing either one stream of the three-dimensional (3D) video stream for a left eye or for a right eye thereof, each image being encoded one by one for the left eye or for the right eye; and a Mux unit, which is configured to multiplex said two-dimensional (2D) video stream after said encoding and an audio stream.
